(19) United States
(12) Patent Application Publication
(10) Pub. No.: US 2006/0185970 A1
(43) Pub. Date: Aug. 24, 2006

(54) VEHICLE LATCH ARRANGEMENT

(75) Inventor: John Stack, Shelby Township, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/906,418

(22) Filed: Feb. 18, 2005

(51) Int. Cl. H01H 3/16

(52) U.S. Cl. 200/61.62

(57) ABSTRACT

A trim assembly for a motor vehicle includes a component that is moveable between first and second positions, and a first latch member associated with the component and having first and second latch features and an intermediate surface disposed between the latch features. The assembly further includes a second latch member that is selectively engageable with the first and second latch features of the first latch member to retain the component in the first and second positions, respectively. The second latch member is also engageable with the intermediate surface when the component moves between the first and second positions to dampen movement of the component.

### BACKGROUND OF THE INVENTION

1. Field of the Invention

The invention relates to a vehicle trim assembly having a latch arrangement.

2. Background Art

A prior latch system for use with a moveable trim component includes a positive latching device for locking the component in a raised position. The system further includes a viscous drive for dampening movement from the raised position toward a lowered position.

### SUMMARY OF THE INVENTION

Under the invention, a trim assembly for use with a motor vehicle is provided. In one embodiment, the assembly includes a component that is moveable between first and second positions, and a first latch member associated with the component and having first and second latch features and an intermediate surface disposed between the latch features. The assembly further includes a second latch member that is selectively engageable with the first and second latch features of the first latch member to retain the component in the first and second positions, respectively. The second latch member is also engageable with the intermediate surface when the component moves between the first and second positions to dampen movement of the component.

In another embodiment, the assembly includes a component that is moveable between first and second positions, a first latch member associated with the component and having first and second latch features, and a second latch member that is selectively engageable with the first and second latch features of the first latch member to retain the component in the first and second positions, respectively. The assembly further includes a release device associated with the second latch member for disengaging the second latch member from the first latch feature of the first latch member when the component is in the first position. Furthermore, the second latch member is configured to disengage the second latch feature when the component is moved from the second position toward the first position.

In yet another embodiment, the assembly includes a component that is moveable between first and second positions, a first latch member associated with the component and having first and second latch features, and a pivotable second latch member that is engageable with the first latch feature of the first latch member to retain the component in the first position. The second latch member is also disengageable from the first latch feature to allow movement of the component to the second position. In addition, the second latch member is engageable with the second latch feature of the first latch member to retain the component in the second position.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a perspective view of a trim assembly, according to the invention, having a moveable component shown in a raised first position;

FIG. 2 is a perspective view of the trim assembly of FIG. 1 showing the component in a lowered second position;

FIG. 3 is a schematic cross-sectional view of the trim assembly showing first and second latch members engaged with each other to maintain the component in the first position;

FIG. 4 is a schematic cross-sectional view of the trim assembly showing the component positioned between the first and second positions;

FIG. 5 is a schematic cross-sectional view of the trim assembly showing the first and second latch members engaged with each other to maintain the component in the second first position;

FIG. 6 is a perspective view of a second embodiment of the trim assembly including a moveable component shown in a lowered first position;

FIG. 7 is a perspective view of the trim assembly of FIG. 6 showing the component in a raised second position;

FIG. 8 is a perspective view of a third embodiment of the trim assembly including a moveable component shown in a raised first position; and

FIG. 9 is a perspective view of the trim assembly of FIG. 8 showing the component in a lowered second position.

### DETAILED DESCRIPTION OF THE PREFERRED EMBODIMENT(S)

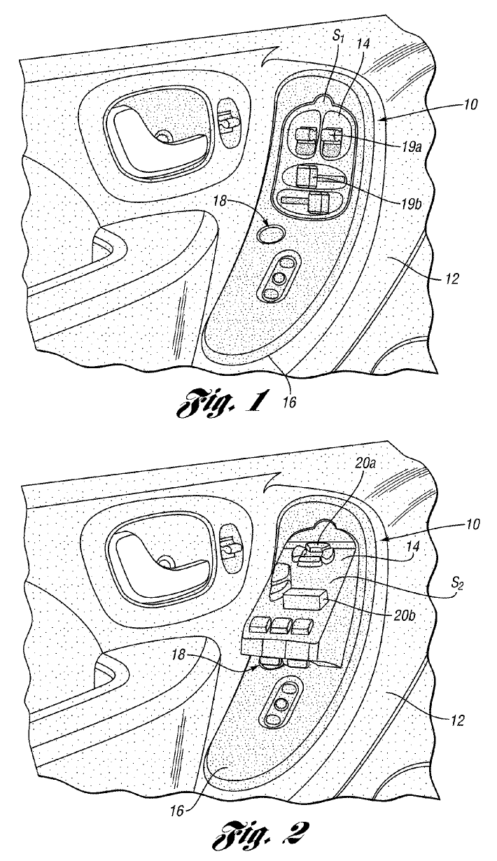

FIGS. 1 and 2 show a trim assembly 10 according to the invention for use with a motor vehicle. In the embodiment shown in FIGS. 1 and 2, the trim assembly 10 includes a switch assembly mounted on a door panel 12. Furthermore, the trim assembly 10 includes a trim component 14 that is moveable between first and second positions. For example, the component 14 may be a switch module or switch bank that is pivotally attached to a mounting portion such as frame or bezel 16, such that the component 14 is pivotable between a first or raised position shown in FIG. 1 and a second or lowered position shown in FIG. 2. In addition, the trim assembly 10 includes a latch arrangement 18 for retaining the component 14 in the first and second positions.

In the embodiment shown in FIGS. 1 and 2, the component 14 includes a first side S₁ having one or more control switches 19a-b that are accessible when the component 14 is in the first position. When the component 14 is moved to the second position, access is provided to one or more additional control switches 20a-b disposed on a second side S₂. The control switches 19a-b and 20a-b may include any suitable switches for controlling any suitable vehicle accessory or component. For example, the control switches 19a-b may include power window switches 19a and foot pedal adjustment switches 19b, and the additional control switches 20a-b may include mirror position control switches 20a and seat position adjustment switches 20b.

Referring to FIGS. 3-5, details of the latch arrangement 18 will now be described. The latch arrangement 18 includes first and second latch members 21 and 22, respectively, that cooperate to lock the component 14 in the first and second positions. The first latch member 21 is associated with the component 14 and is moveable therewith. For example, the first latch member 21 and the component 14 may each be fixedly mounted on a first shaft 24 that is rotatably mounted on the bezel 16, such that the first latch member 21 and component 14 are pivotable about a first axis 25 extending through the first shaft 24. Furthermore, the first latch member 21 and the component 14 may be spaced apart from each other to accommodate various design configurations.

The first latch member 21 also has first and second latch features, such as first and second latch surfaces 26 and 28, respectively. In the embodiment shown in FIGS. 3-5, the first latch surface 26 defines a latch recess. As another example, the first latch surface 26 may be an end surface of the first latch member 21. Alternatively, the first latch member 21 may be provided with any suitable latch features.

The second latch member 22 is moveable with respect to the first latch member 21, and is selectively engageable with the first and second latch surfaces 26 and 28, respectively. For example, the second latch member 22 may be mounted on a second shaft 30 that is rotatably mounted on the bezel 16, such that the second latch member 22 is pivotable about a second axis 32 spaced apart from the first axis 25. In the embodiment shown in FIGS. 3-5, the second latch member 22 includes an elongated latch arm 34 and a latch head 36 connected to the latch arm 34. The latch head 36 is engageable with the first latch surface 26 of the first latch member 21 when the component 14 is in the first position, as shown in FIG. 3, to maintain the component 14 in the first position. The latch head 36 also includes an angled latch surface 38 that is engageable with the second latch surface 28 of the first latch member 21 when the component 14 is in the second position, as shown in FIG. 5, to maintain the component 14 in the second position.

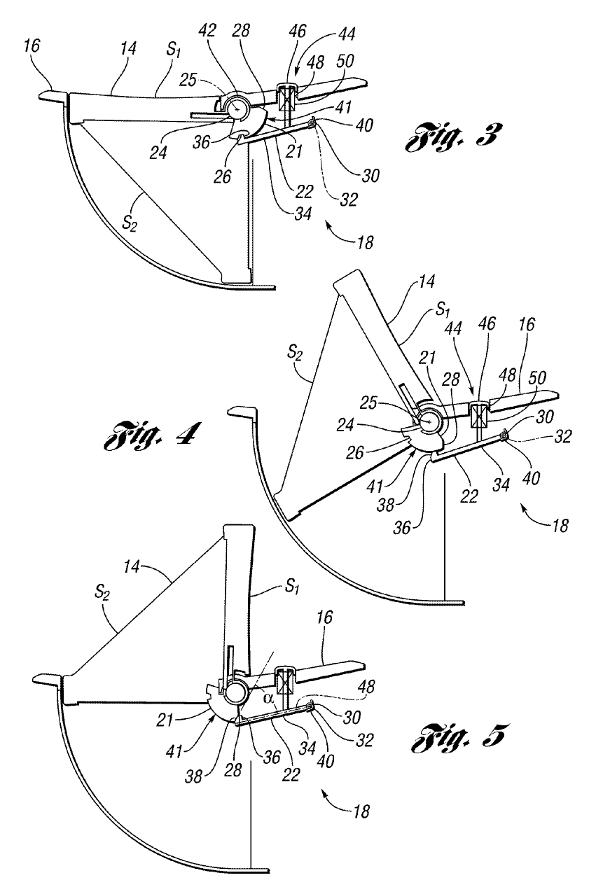

In the embodiment shown in FIGS. 3-5, the latch arrangement 18 also includes a biasing member 40 that is configured to urge the second latch member 22 toward the first latch member 21. For example, the biasing member 40 may be a torsion spring disposed about the second shaft 30 and engaged with the second latch member 22 and the bezel 16. With biasing member 40, the second latch member 22 may be urged into engagement with an intermediate surface 41 of the first latch member 21 when the component 14 moves between the first and second positions, as shown in FIG. 4. As a result, movement of the component 14 may be dampened by the latch arrangement 18.

The trim assembly 10 may also include an additional biasing member 42 for urging the component 14 toward the second position. For example, the additional biasing member 42 may be a torsion spring disposed about the first shaft 24 and engaged with the bezel 16 and the first latch member 21 or the component 14.

The latch arrangement 18 may further include a release device 44 associated with the second latch member 22 for disengaging the second latch member 22 from the first latch surface 26 of the first latch member 21 when the component 14 is in the first position. In the embodiment shown in the Figures, the release device 44 includes a release member, such as a push button 46, connected to the second latch member 22. The push button 46 is received in an aperture 48 of the bezel 16 and is moveable between an initial position, shown in FIG. 3, and a release position, shown in FIG. 4. The release device 44 may further include a biasing member, such as a return spring 50, for urging the push button 46 toward the initial position.

Referring to FIGS. 1-5, operation of the assembly 10 will now be described. As mentioned above, access is provided to the control switches 19a-b when the component 14 is in the first position. Furthermore, referring to FIG. 3, the latch head 36 of the second latch member 22 is engaged with the first latch surface 26 of the first latch member 21 when the component 14 is in the first position to retain the component 14 in the first position.

When it is desired to access the additional control switches 20a-b, the push button 46 may be depressed to disengage the latch head 36 from the first latch surface 26. The biasing member 42 then automatically urges the component 14 toward the second position. As the component 14 moves from the first position toward the second position, the latch head 36 engages the intermediate surface 41 of the first latch member 21, as shown in FIG. 4, to dampen movement of the component 14.

When the component 14 reaches the second position shown in FIG. 5, the angled surface 38 of the latch head 36 engages the second latch surface 28 of the first latch member 21 to retain the component 14 in the second position. The component 14 may then be returned to the first position by manually urging the component 14 toward the first position, without using the release device 44.

The effort required to disengage the latch members 21 and 22 when the component 14 is in the second position is a function of the amount of effort required to overcome spring forces of biasing members 40 and 42, and the amount of effort required to deflect angled surface 38 along angled second latch surface 28. The closer to a perpendicular relationship the angled surface 38 and the second latch surface 28 are with respect to axis 48 of second latch member 22 (i.e., the closer angle α is to 90 degrees), the greater the effort required to disengage the latch members 21 and 22 when the component 14 is in the second position. The closer angle α is to 0 degrees, the smaller the effort required to disengage the latch members 21 and 22 when the component 14 is in the second position.

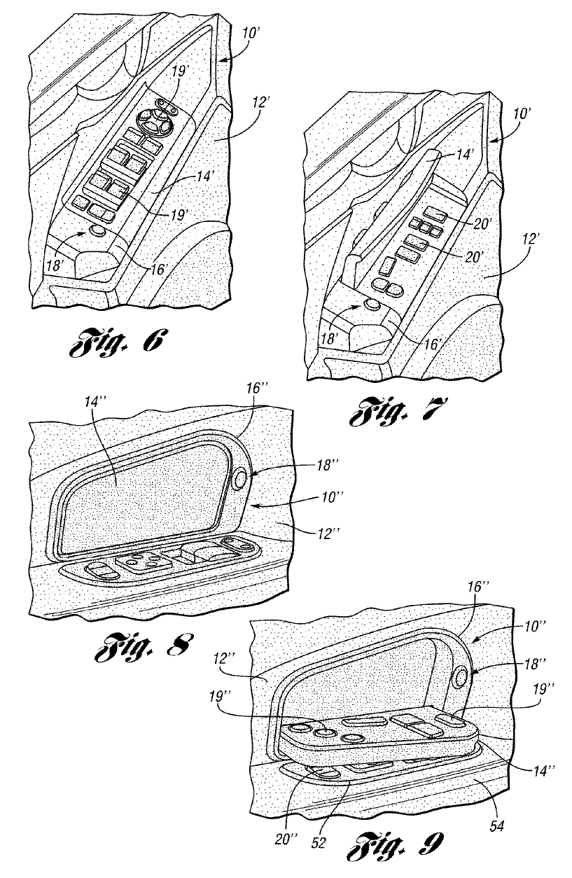

FIGS. 6 and 7 show a second embodiment 110′ of the trim assembly, which may be referred to as a “flip up” configuration, mounted on door panel 12′. The assembly 110′ includes a component 14′, such as a switch module or switch bank, that is pivotable with respect to a mounting portion, such as frame or bezel 16′, between a first or lowered position shown in FIG. 6, and a second or raised position shown in FIG. 7. The assembly 110′ further includes a latch arrangement 18′ for retaining the component 14′ in the first and second positions. The latch arrangement 18′ may have a similar configuration and function in a similar manner as described above with respect to latch arrangement 18. Furthermore, in the embodiment shown in FIGS. 6 and 7, control switches 19′ are disposed on a top surface of the component 14′, and additional control switches 20′ are disposed on the bezel 16′. Thus, the component 14′ covers the additional control switches 20′ when the component 14′ is in the first position.

FIGS. 8 and 9 show a third embodiment 10″ of the trim assembly, which may be referred to as a “drop down” configuration, mounted on door panel 12″. The assembly 10″ includes a component 14″, such as a switch module or switch bank, that is pivotable with respect to a mounting portion, such as frame or bezel 16″, between a first or raised position shown in FIG. 8, and a second or lowered position shown in FIG. 9. The assembly 10″ further includes a latch arrangement 18″ for retaining the component 14″ in the first and second positions. The latch arrangement 18″ may have a similar configuration and function in a similar manner as described above with respect to latch arrangement 18. Furthermore, in the embodiment shown in FIGS. 8 and 9, control switches 19″ are disposed on one side of the component 14″, and additional control switches 20″ are disposed on an additional frame or bezel 52 that is mounted on an armrest 54 of door panel 12″.

Alternatively, the trim assembly 10 may be any suitable automotive trim assembly having a moveable component. For example, the trim assembly 10 may be a console assembly having a moveable cover or door.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A trim assembly for a motor vehicle comprising:
a component that is moveable between first and second positions;
a first latch member associated with the component and having first and second latch features and an intermediate surface disposed between the latch features; and
a second latch member that is selectively engageable with the first and second latch features of the first latch member to retain the component in the first and second positions, respectively, the second latch member further being engageable with the intermediate surface when the component moves between the first and second positions to dampen movement of the component.

2. The assembly of claim 1 further comprising a biasing member associated with the second latch member for urging the second latch member toward the first latch member.

3. The assembly of claim 1 wherein the component is pivotable about a first axis between the first and second positions, and wherein the second latch member is pivotable about a second axis spaced apart from the first axis.

4. The assembly of claim 3 wherein the first latch member is pivotable about the first axis.

5. The assembly of claim 1 wherein the second latch member is configured to disengage the second latch feature when the component is moved from the second position toward the first position.

6. The assembly of claim 5 wherein the second latch feature of the first latch member comprises a latch surface, and the second latch member has an angled latch surface that is engageable with the latch surface of the first latch member when the component is in the second position.

7. The assembly of claim 1 further comprising a release device associated with the second latch member for disengaging the second latch member from the first latch feature.

8. The assembly of claim 7 wherein the release device includes a release member that is moveable between an initial position and a release position for disengaging the second latch member from the first latch feature of the first latch member, and a biasing member for urging the release member toward the initial position.

9. The assembly of claim 7 wherein the second latch member is pivotable about an axis.

10. The assembly of claim 1 wherein the component includes an electrical switch.

11. A trim assembly for a motor vehicle comprising:
a component that is moveable between first and second positions;
a first latch member associated with the component and having first and second latch features;
a second latch member that is selectively engageable with the first and second latch features of the first latch member to retain the component in the first and second positions, respectively; and
a release device associated with the second latch member for disengaging the second latch member from the first latch feature of the first latch member when the component is in the first position;
wherein the second latch member is configured to disengage the second latch feature when the component is moved from the second position toward the first position.

12. The assembly of claim 11 wherein the second latch feature of the first latch member comprises a latch surface, and the second latch member has an angled latch surface that is engageable with the latch surface of the first latch member when the component is in the second position.

13. The assembly of claim 11 wherein the first latch member has an intermediate surface disposed between the first and second latch features, and wherein the second latch member is engageable with the intermediate surface when the component moves between the first and second positions to dampen movement of the component.

14. The assembly of claim 11 wherein the second latch member is pivotable about an axis.

15. The assembly of claim 14 further comprising a biasing member associated with the second latch member for urging the second latch member toward the first latch member.

16. The assembly of claim 11 wherein the component and the second latch member are pivotable about a first axis, and wherein the second latch member is pivotable about a second axis spaced apart from the first axis.

17. A trim assembly for a motor vehicle comprising:
a component that is moveable between first and second positions;
a first latch member associated with the component and having first and second latch features;
a pivotable second latch member that is engageable with the first latch feature of the first latch member to retain the component in the first position, the second latch member being disengageable from the first latch feature to allow movement of the component to the second position, and the second latch member further being engageable with the second latch feature of the first latch member to retain the component in the second position.

18. The assembly of claim 17 wherein the component and the first latch member are pivotable about a first axis, and wherein the second latch member is pivotable about a second axis spaced apart from the first axis.

19. The assembly of claim 18 further comprising a release device associated with the second latch member for disengaging the second latch member from the first latch feature, and wherein the second latch member is configured to automatically disengage the second latch feature when the component is moved from the second position toward the first position.

20. The assembly of claim 19 wherein the second latch feature of the first latch member comprises a latch surface, and the second latch member has an angled latch surface that is engageable with the latch surface of the first latch member when the component is in the second position.
